(19) United States
(12) Patent Application Publication
(10) Pub. No.: US 2009/0071278 A1
(43) Pub. Date: Mar. 19, 2009

(54) Ball screw device having image sensor

(75) Inventors: Yueh Ling Chiu, Taichung (TW); Wen Chia Wu, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 11/901,562

(22) Filed: Sep. 18, 2007

(51) Int. Cl. F16H 25/22

(52) U.S. Cl. 74/424.82

(57) ABSTRACT

A ball screw device includes a number of bearing members received between a ball nut and a screw shaft, and an image device engaged into the bore of the ball nut, and directed toward the screw shaft but spaced from the screw shaft for taking an image of the screw shaft and for viewing a changing of the inner thread of the screw shaft and for allowing the users to change or to replace the worn out ball nut and/or the worn out screw shaft and/or the worn out bearing members right away or at the best time. A processor device may be coupled to the image device for processing the images taken by the image device. A displayer may display the images, and a warning device may generate a warning signal when the screw shaft has been worn out.

### BACKGROUND OF THE INVENTION

1. Field of the Invention

The present invention relates to a ball screw device, and more particularly to a ball screw device having an image sensor for viewing the balls or the rollers or the bearing members or the ball nut or the screw shaft, and for detecting or sensing whether the screw shaft has been worn out or not, and for allowing the users to view and to know whether the ball nut and/or the screw shaft has been worn out or not, and for allowing the users to change or to replace the ball nut and/or the screw shaft and/or the bearing members right away or at the best time.

2. Description of the Prior Art

Typical ball screw devices comprise a ball nut rotatably and/or moveably engaged onto a screw shaft, and normally arranged to allow the ball nut to be rotated and/or moved relative to the screw shaft in great rotational speeds. For allowing the ball nut to be smoothly rotated and moved relative to the screw shaft, a suitable bearing device or lubricating structure is further required to be provided and engaged between the ball nut and the screw shaft, for facilitating the rotational movement between the ball nut and the screw shaft.

For example, U.S. Pat. No. 4,953,419 to Schlenker, and U.S. Pat. No. 5,063,809 to Schlenker disclose two typical ball screw and nut assemblies each including a number of balls or rollers or bearing members disposed or engaged between the ball nut and the screw shaft for facilitating the rotational movement of the ball nut and the screw shaft relative to each other.

However, the balls or rollers or bearing members are engaged and shielded between the ball nut and the screw shaft, and the wear of the ball nut and/or the screw shaft and/or the bearing members may not be seen or detected or viewed by the users such that the users may not know when the balls or rollers or bearing members or the ball nut or the screw shaft has been worn out or not, and may not know the best time to change or to replace the balls or rollers or bearing members or the ball nut or the screw shaft.

U.S. Pat. No. 5,014,568 to Schlenker and U.S. Pat. No. 6,023,991 to Tabe et al. disclose two further typical ball screw and nut assemblies each also including a number of balls or rollers or bearing members disposed or engaged between the ball nut and the screw shaft for facilitating the rotational movement of the ball nut and the screw shaft relative to each other.

However, similarly, the balls or rollers or bearing members are also engaged and received and shielded between the ball nut and the screw shaft, and the wear of the ball nut and/or the screw shaft and/or the bearing members may not be seen or detected or viewed by the users such that the users may not know when the balls or rollers or bearing members or the ball nut or the screw shaft has been worn out or not, and may not know the best time to change or to replace the balls or rollers or bearing members or the ball nut or the screw shaft.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including an image sensor for viewing the balls or the rollers or the bearing members or the ball nut or the screw shaft, and for detecting or sensing whether the screw shaft has been worn out or not, and for allowing the users to view and to know whether the ball nut and/or the screw shaft has been worn out or not, and for allowing the users to change or to replace the ball nut and/or the screw shaft and/or the bearing members right away or at the best time.

In accordance with one aspect of the invention, there is provided a ball screw device comprising a screw shaft including an outer thread formed thereon, and including a number of peripheral and helical groove portions and a number of peripheral and helical ridges for forming the outer thread of the screw shaft, a ball nut including a bore formed therein for receiving the screw shaft, and including an inner thread formed therein for engaging with the outer thread of the screw shaft and for forming a helical raceway between the ball nut and the screw shaft, the inner thread of the ball nut including a number of peripheral and helical groove portions and a number of peripheral and helical ridges formed therein, a number of bearing members received in the helical raceway between the ball nut and the screw shaft for facilitating a rotating movement between the ball nut and the screw shaft, and an image device attached to the ball nut for taking an image of the screw shaft and for viewing or sensing or detecting a changing of the outer thread of the screw shaft.

The ball nut includes a cavity formed therein for receiving the image device therein, and the image device is engaged into the bore of the ball nut and directed toward the screw shaft but spaced from the screw shaft. The ball nut includes an enlarged actuator end flange formed in one side portion of the ball nut, and the cavity is formed in the actuator end flange of the ball nut and communicating with the bore of the ball nut.

A processor device may further be provided and coupled to the image device for receiving images taken by the image device and for comparing or processing the images taken by the image device and for determining the changing of the ball nut and/or the screw shaft and/or the bearing members, and for determining whether the ball nut and/or the screw shaft and/or the bearing members have been worn out or not.

A displayer may further be provided and coupled to the processor device for displaying the images taken by the image device for allowing the users to view and to know whether the ball nut and/or the screw shaft has been worn out or not, and for allowing the users to change or to replace the worn out ball nut and/or the worn out screw shaft and/or the worn out bearing members right away or at the right time or the best time.

A warning device may further be provided and coupled to the processor device for generating a warning signal when the ball nut and/or the screw shaft and/or the bearing members have been worn out.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a ball screw device in accordance with the present invention;

FIG. 2 is a partial exploded view of the ball screw device;

FIG. 3 is a plan schematic view of the ball screw device, in which a portion of the outer ball nut has been cut off for showing an inner structure of the ball screw device;

FIG. 4 is an enlarged partial cross sectional view illustrating the image sensor of the ball screw device;

FIG. 5 is a block diagram illustrating the image sensing device for the ball screw device;

FIGS. 6, 8 are enlarged partial cross sectional views similar to FIG. 4, illustrating the wear and the tear of the bearing members or the ball nut or the screw shaft; and

FIGS. 7, 9 are enlarged partial plan schematic views of the ball screw device as shown in FIGS. 6, 8 respectively, viewed or taken by the image sensor of the ball screw device.

### DETAILED DESCRIPTION OF THE PREFERRED EMBODIMENT

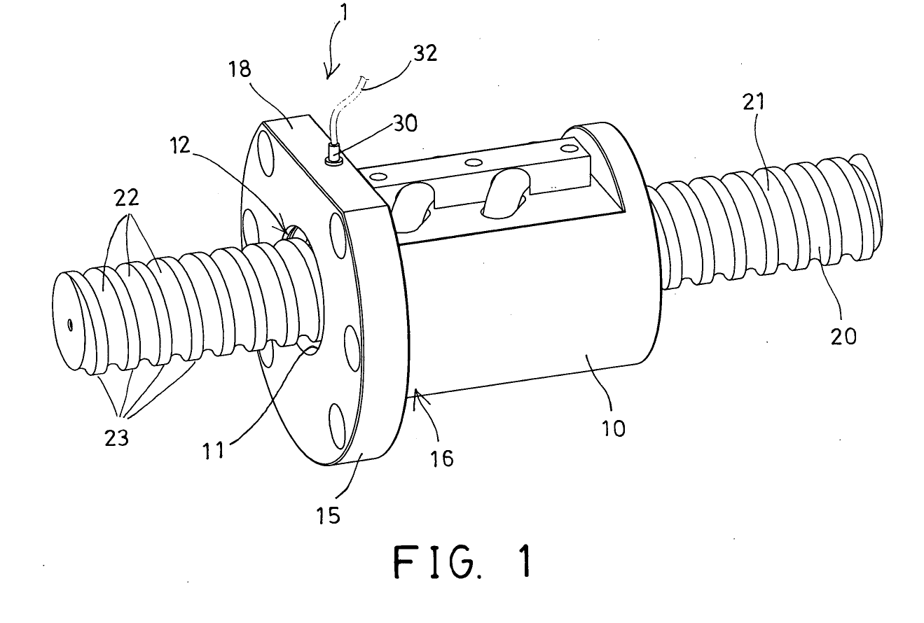

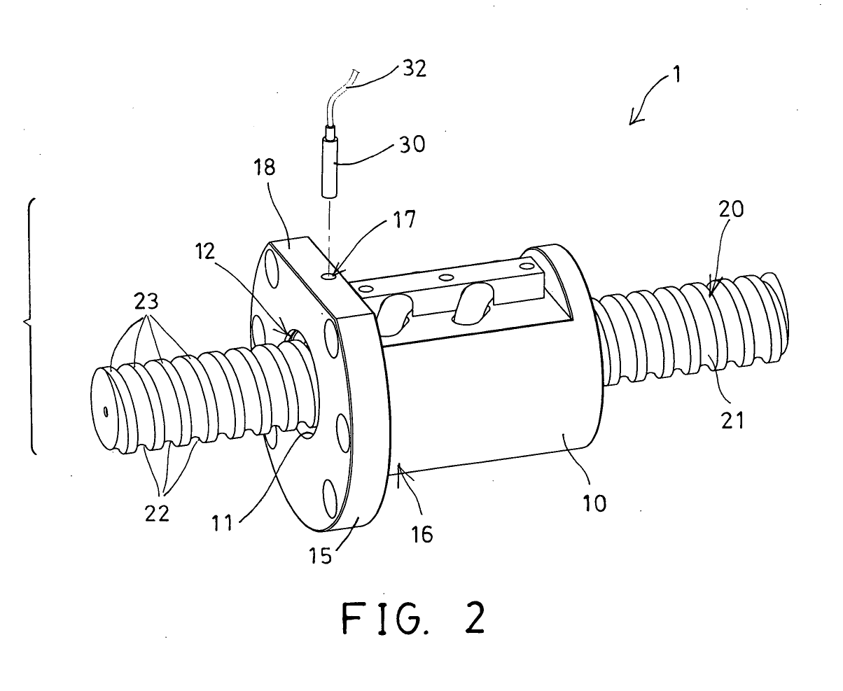

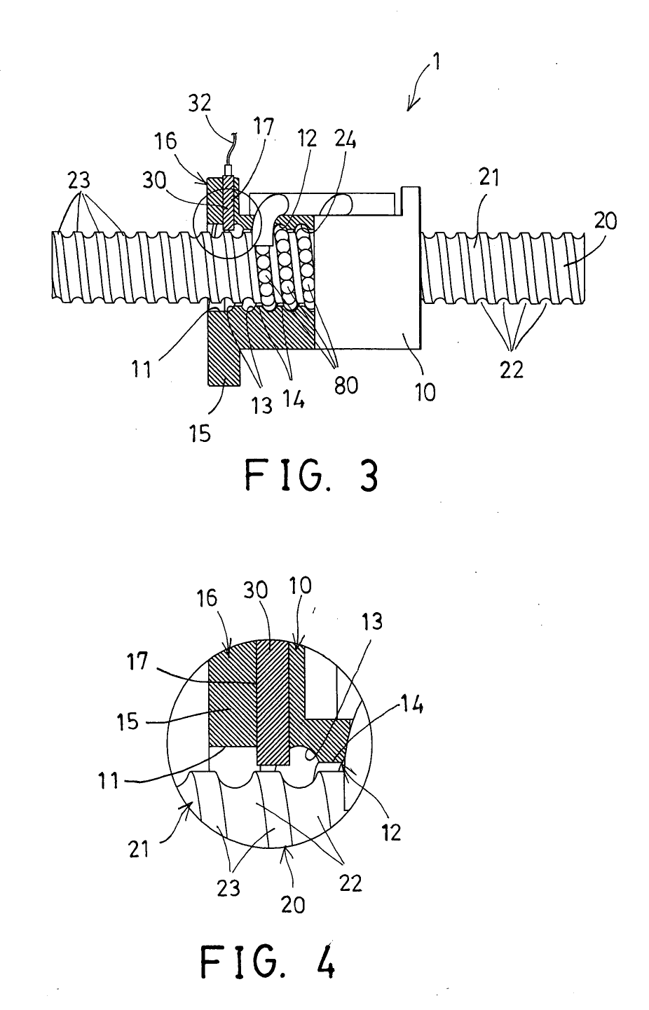

Referring to the drawings, and initially to FIGS. 1-3, a ball screw device 1 in accordance with the present invention comprises an outer ball nut 10 including a bore 11 formed therein for receiving a typical screw shaft 20 and having an inner thread 12 formed therein for threading with or for engaging with an outer thread 21 of the screw shaft 20 and for allowing the ball nut 10 to be moved along the screw shaft 20, or for allowing the screw shaft 20 to be rotated and moved relative to the ball nut 10. The inner thread 12 of the ball nut 10 includes a number of peripheral and helical groove portions 13 formed and defined by a number of peripheral and helical ridges 14 (FIGS. 3, 4), and the outer thread 21 of the screw shaft 20 also includes a number of peripheral and helical groove portions 22 formed and defined by a number of peripheral and helical ridges 23 (FIGS. 1-3).

The threading engagement and/or the rotational engagement between the ball nut 10 and the screw shaft 20 is typical and will not be described in further details. A multiple turn, helical raceway 24 will be formed between the ball nut 10 and the screw shaft 20 for rotatably and/or movably receiving one or more groups of balls or rollers or rolling or ball bearing members 80 therein (FIG. 3) which may facilitate the rotating movement of the ball nut 10 relative to the screw shaft 20 when the screw shaft 20 is forced to rotate relative to the ball nut 10 or when the ball nut 10 is forced to rotate relative to the screw shaft 20. The ball nut 10 includes an enlarged actuator end flange 15 formed in one side portion 16 thereof, and includes a cavity 17 formed in the ball nut 10, such as formed through the actuator end flange 15 of the ball nut 10 and communicating with the bore 11 of the ball nut 10 (FIGS. 3, 4, 6, 8), and a cut off portion or recess or notch or flat surface 18 formed in the outer peripheral portion of the actuator end flange 15 of the ball nut 10.

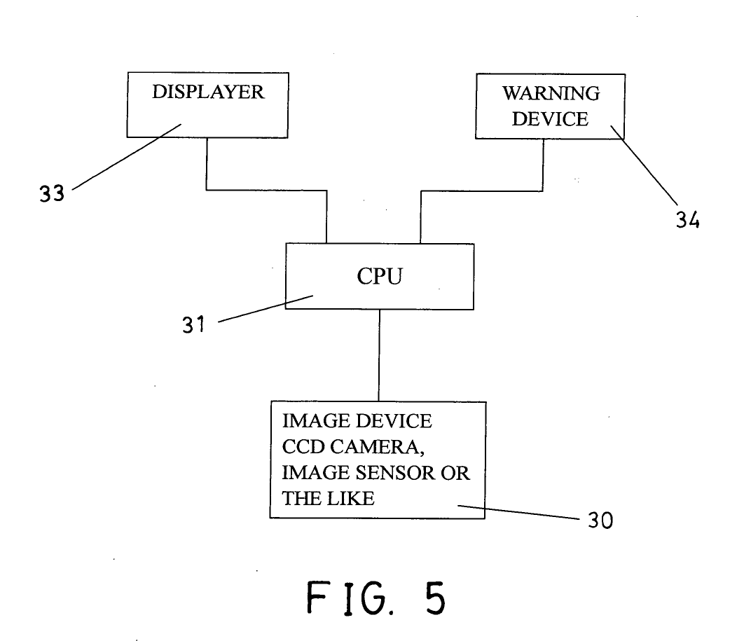

An image device 30, such as a charge couple device (CCD), a camera, an image sensor, an image detector, an image scanner or the like is engaged with or into the cavity 17 of the ball nut 10, and engaged into the bore 11 of the ball nut 10 (FIGS. 3, 4, 6, 8), and facing or directing toward the screw shaft 20, but spaced away from the screw shaft 20 for taking the image of the screw shaft 20 (FIGS. 7, 9) and for viewing the changing or the wear or the tear of the peripheral and helical groove portions 22 and/or the peripheral and helical ridges 23 of the screw shaft 20. As shown in FIG. 5, the image device 30 may be coupled to a control or processor device or central processing unit (CPU) 31 with an electric cable 32, and the processor device 31 may then be coupled to a displayer 33 and/or a warning device 34, such as a buzzer, a warning light device, or the like for generating a warning signal.

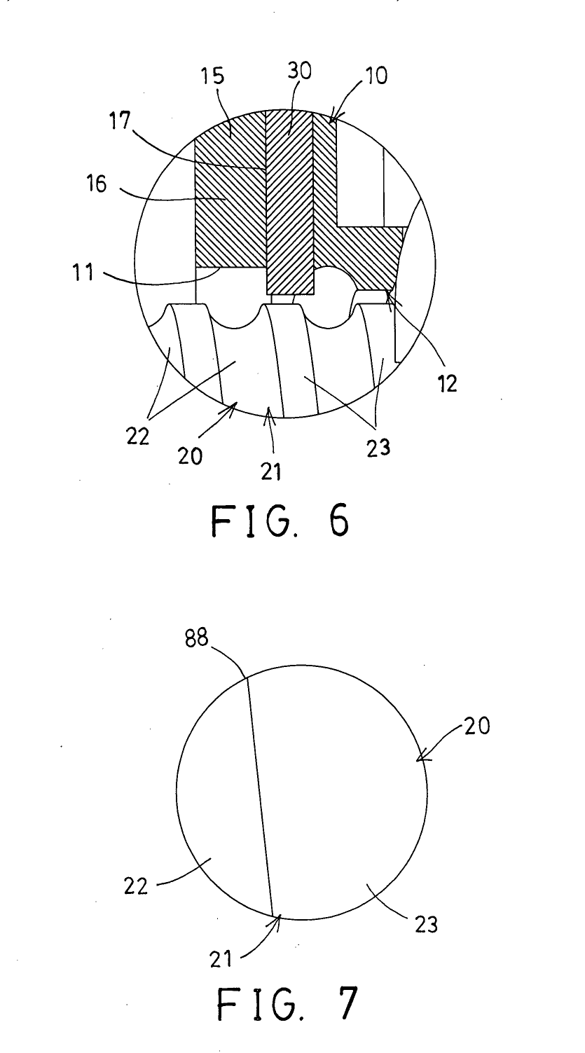

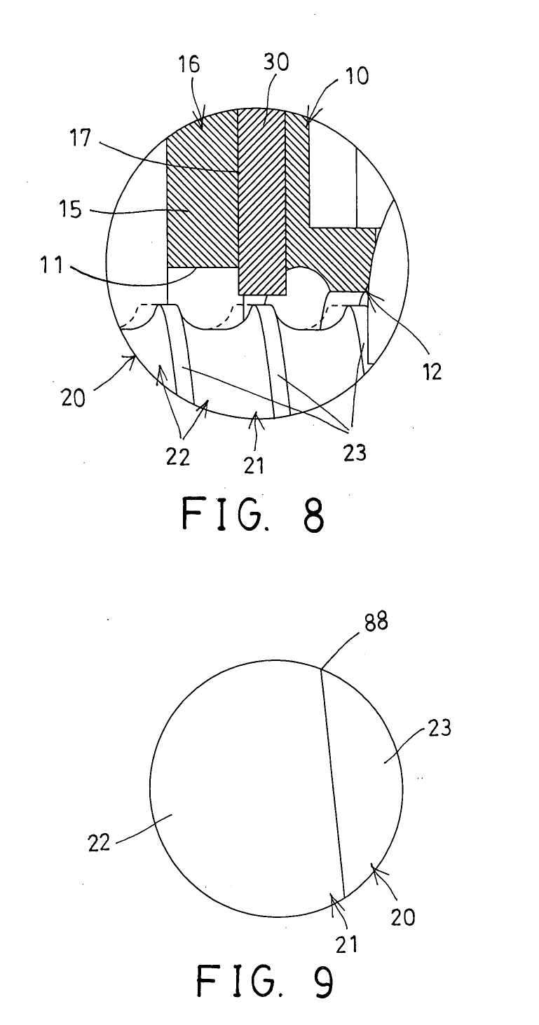

In operation, as shown in FIGS. 6 and 7, before working, or when the ball nut 10 and/or the screw shaft 20 and/or the ball bearing members 80 are the new ones, or when the ball nut 10 and/or the screw shaft 20 and/or the ball bearing members 80 have not been worn out, the image device 30 may take the image as shown in FIG. 7 and may send the image as a reference image or data in the processor device 31 or may have the image stored in various kinds of storing or memorizing media. As shown in FIGS. 8-9, after working, or when the ball nut 10 and/or the screw shaft 20 and/or the ball bearing members 80 have been worn out, the image device 30 may take the other image as shown in FIG. 9, and may send the other image to the processor device 31, and may have the other image compared with the reference image or data stored in the storing or memorizing media or in the processor device 31 by the processor device 31.

It is to be noted that the peripheral and helical groove portions 22 and/or the peripheral and helical ridges 23 of the screw shaft 20 may be shifted longitudinally or sidewise relative to the ball nut 10 and the image device 30 when the peripheral and helical groove portions 22 and/or the peripheral and helical ridges 23 of the screw shaft 20 have been worn out, or when the peripheral and helical groove portions 13 and/or the peripheral and helical ridges 14 of the ball nut 10 have been worn out, or when the ball bearing members 80 have been worn out, or the like, such that the reference line 88 between the peripheral and helical groove portions 22 and the peripheral and helical ridges 23 of the screw shaft 20 may be taken as a reference line 88 for comparing the longitudinal or sidewise shifting between the ball nut 10 and the screw shaft 20 and may be used to determine whether the ball nut 10 and/or the screw shaft 20 have been worn out or not.

The images taken by the image device 30 as shown in FIGS. 7 and 9 may be seen through the displayer 33 as shown in FIG. 5, for allowing the users to view and to know whether the ball nut 10 and/or the screw shaft 20 has been worn out or not, and for allowing the users to change or to replace the worn out ball nut 10 and/or the worn out screw shaft 20 and/or the worn out bearing members 80 right away or at the best time. When the reference line 88 has been detected to be shifted longitudinally or sidewise relative to the ball nut 10 for a predetermined distance, or when the ball nut 10 and/or the screw shaft 20 and/or the ball bearing members 80 have been worn out, the warning device 34 may be actuated by the processor device 31 to generate a warning signal, such as a buzzer sound or a warning light or the like, and to notify the users that the ball nut 10 and/or the screw shaft 20 and/or the ball bearing members 80 have been worn out, such that the users to change or to replace the worn out ball nut 10 and/or the worn out screw shaft 20 and/or the worn out bearing members 80 right away or at the right time or at the best time.

Accordingly, the ball screw device in accordance with the present invention includes an image device for viewing the balls or the rollers or the bearing members or the ball nut or the screw shaft, and for detecting or sensing whether the screw shaft has been worn out or not, and for allowing the users to view and to know whether the ball nut and/or the screw shaft has been worn out or not, and for allowing the users to change or to replace the ball nut and/or the screw shaft and/or the bearing members right away or at the best time.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a screw shaft including an outer thread formed thereon, and including a plurality of peripheral and helical groove portions and a plurality of peripheral and helical ridges for forming said outer thread of said screw shaft,
a ball nut including a bore formed therein for receiving said screw shaft, and including an inner thread formed therein for engaging with said outer thread of said screw shaft and for forming a helical raceway between said ball nut and said screw shaft, said inner thread of said ball nut including a plurality of peripheral and helical groove portions and a plurality of peripheral and helical ridges formed therein,
a plurality of bearing members received in said helical raceway between said ball nut and said screw shaft for facilitating a rotating movement between said ball nut and said screw shaft, and
an image device attached to said ball nut for taking an image of said screw shaft and for viewing a changing of said outer thread of said screw shaft.

2. The ball screw device as claimed in claim 1, wherein said ball nut includes a cavity formed therein for receiving said image device therein, and said image device is engaged into said bore of said ball nut and directed toward said screw shaft but spaced from said screw shaft.

3. The ball screw device as claimed in claim 2, wherein said ball nut includes an enlarged actuator end flange formed in one side portion of said ball nut, and said cavity is formed in said actuator end flange of said ball nut and communicating with said bore of said ball nut.

4. The ball screw device as claimed in claim 1 further comprising a processor device coupled to said image device for receiving images taken by said image device.

5. The ball screw device as claimed in claim 4 further comprising a displayer coupled to said processor device for displaying the images taken by said image device.

6. The ball screw device as claimed in claim 4 further comprising a warning device coupled to said processor device for generating a warning signal.
